(19) United States
(12) Patent Application Publication
(10) Pub. No.: US 2019/0047168 A1
(43) Pub. Date: Feb. 14, 2019

(54) SHEET INTERLEAVER FOR SLICING MACHINE

(71) Applicant: PROVISUR TECHNOLOGIES, INC., Chicago, IL (US)

(72) Inventor: Jürgen Bialy, Altenberge (DE)

(21) Appl. No.: 15/672,640

(22) Filed: Aug. 9, 2017

(51) Int. Cl. B26D 7/32; B65B 25/06; A22C 17/00

(52) U.S. Cl. CPC B26D 7/325; B65B 25/06; B65G 57/11; B26D 2210/02; A22C 17/0093

(57) ABSTRACT

In one aspect, a sheet interleaver for a slicing machine having a slicing station for slicing a food product is provided. The sheet interleaver includes a feed device for providing a sheet material between slices of the food product and an electrostatic charging system configured to generate an electrostatic charge. The electrostatic charge generates a force urging the sheet material to move in a direction toward the food product. In one aspect, a method for coupling a sheet material to a food product configured to be sliced by a slicing machine is provided. The method includes feeding a sheet material for positioning between slices of the food product and generating an electrostatic charge to generate a force urging the sheet material to move in a direction toward the food product.

### FIELD OF THE INVENTION

The present disclosure generally relates to food slicing machines. More particularly, the present disclosure relates to a sheet interleaver for a food slicing machine.

### BACKGROUND

Food loaves come in a variety of shapes (round, square, rectangular, oval, etc.), cross-sections, and lengths. Such loaves are made from various comestibles, such as meat, cheese, etc. Most loaves are provided to an intermediate processor who slices and packages the products in groups for retail.

A variety of machines have been developed to slice such loaves. Such machines include the PowerMax 4500®, the PowerMax 3500™ or the PowerMax 3000™ slicing systems available from Formax, Inc., of Mokena, Ill., USA. Those slicing systems are high speed food loaf slicing machines that slice one, two, or more food loaves simultaneously using one cyclically driven slicing blade. Independent loaf feed drives are provided so that slices cut from one loaf may vary in thickness from slices cut from the other loaf. The machines include a slicing station that is enclosed by a housing, except for a limited slicing opening. The slicing blade is disposed in the slicing station and a drive rotates the slicing blade at a predetermined cyclical rate on a cutting path through a slicing range that intersects the food loaves as they are fed into the slicing station.

In the foregoing machines, the food loaf slices are received in groups of predetermined weight on a receiving or portioning conveyor that is disposed adjacent the slicing blade. The receiving conveyor receives the slices as they are cut by the slicing blade. In many instances, neatly aligned stacked groups are preferred and, as such, the sliced product is stacked on the receiving conveyor before being transferred from the machine. In other instances, the groups are shingled so that a purchaser can see a part of every slice through a transparent package. In these other instances, conveyor belts of the receiving conveyor are gradually moved during the slicing process to separate the slices.

Sheet interleaving mechanisms may be used in conjunction with cutting machines. Examples of sheet interleavers are disclosed in U.S. Pat. Nos. 6,752,056 and 4,583,435. According to these patents, slabs of product such as cheese are oriented angularly with respect to a horizontal conveyor and are fed downwardly into a slicing plane defined by a moving slicing blade. A roll of sheet material such as paper is arranged beneath the slab and has a length of sheet material continuously fed toward and beneath a cut face of the slab. When the cutting blade slices a slice from the slab, the cutting blade simultaneously slices off a leading end portion of the sheet material, forming a sheet. The sheet with the overlying slice fall to the conveyor or onto a previously cut slice already deposited onto the conveyor to form a stack. The web is continuously fed such that successive sheets are interleaved with successive cut slices.

Both of these patents describe the use of air jets to assist in coupling a leading end portion of the sheet material to the front face of the slice to be cut.

The present inventor has recognized that it would be desirable to improve the reliability of the placement of sheets for interleaving with product slices, particularly for high-speed slicing operations.

### SUMMARY

Thus, a need exists for a slicing machine and/or a sheet interleaver that is capable of resolving one or more of the above identified issues.

In one aspect, the present disclosure is directed to a sheet interleaver for a slicing machine having a slicing station for slicing a food product. The sheet interleaver comprises a feed device for providing a sheet material for positioning between slices of the food product. The sheet interleaver comprises an electrostatic charging system configured to generate an electrostatic charge. The electrostatic charge generates a force urging (acting upon) the sheet material to move in a direction to the food product.

In one aspect, the present disclosure may be based in part on the realization that an attachment or coupling of one sheet of a sheet material to a food product can be supported by generating an electrostatic charge. More particularly, the generated electrostatic charge leads to a desired potential difference between oppositely charged elements, or a charged element and a grounded element. The potential difference is used to generate a force urging the sheet material to move in a direction toward and/or to the food product to eventually couple with the food product as desired.

In one aspect, use of the electrostatic charging system is configured to achieve an accurate and reliable coupling of a leading end portion of the sheet material and the food product. Furthermore, the sheet interleaver may no longer use air jets to assist in coupling the sheet material to the food product. Thus, air flows, which may negatively affect an accurate falling and stacking of slices of the food product, can be reduced.

In one aspect, the electrostatic charge generates a force urging the sheet material to move in a direction toward and/or to a previously cut slice of the food product. In another aspect, the electrostatic charge generates a force urging the sheet material to move in a direction toward and/or to a slice to be cut of the food product. In other words, the sheet material may be urged to move to a leading end face of the unsliced elongated body of the food product. In examples where the sheet material may be urged to move to a previous cut slice of the food product, the slice already rests on a stacking area, for example a portioning conveyor. Therefore, based on the specific requirements, the sheet material can be pivoted (upwards) to the leading end face of the elongated body of the food product, or pivoted (downwards) to the stacking area.

In one aspect, the electrostatic charge may generate an attractive force and/or a repulsive force urging the sheet material to move in a direction to the food product.

In one aspect, the force urges the sheet material to couple with the food product.

In one aspect, a leading end portion of the sheet material is urged to move in the direction toward and/or to the food product.

In one aspect, the electrostatic charging system is configured to electrostatically charge the sheet material. The sheet material can be electrostatically charged to generate an attractive force and/or a repulsive force as desired so that the sheet material is urged to move toward and/or to the food product.

In one example, the electrostatic charging system may be configured to electrostatically charge the sheet material at a side facing the slicing station and/or to electrostatically charge the sheet material at a side facing away from the slicing station.

In one aspect, the electrostatic charging system may be configured to electrostatically charge the sheet material by direct contact or to electrostatically charge air or gas contacting the sheet material. Thus, an arrangement and configuration of the electrostatic charging system may be adapted based on, for example, package requirements, sheet interleaver specifications etc.

In one aspect, the electrostatic charging system is configured to electrostatically charge the food product. The food product may be charged to generate an attractive force urging the sheet material to the food product.

In one aspect, the electrostatic charging system is configured to electrostatically charge a slice to be cut of the food product or a previously cut slice of the food product.

In one aspect, the electrostatic charging system is configured to electrostatically charge the food product by direct contact or to electrostatically charge air or gas contacting the food product. Thus, an arrangement and configuration of the electrostatic charging system can be adapted based on, for example, package requirements, sheet interleaver specifications etc.

In one aspect, the electrostatic charging system is configured to electrostatically charge air or gas in a feeding region into which the sheet material is provided by the feed device for positioning between the slices of the food product. The feeding region may be electrostatically charged to generate an attractive force and/or repulsive force as desired so that the sheet material is urged to move to the food product.

In one aspect, the electrostatic charging system is configured to electrostatically charge the sheet material at a side facing the elongated body of the food product, and to electrostatically charge a leading end face of the elongated body of the food product at a side facing the sheet material with an opposite charge. The oppositely charged faces of the sheet material and the elongated body of the food product generate an attractive force between each other.

In one aspect, a side of the sheet material facing away from the elongated body of the food product may be electrostatically charged oppositely to the side facing the elongated body of the food product. As a result, a repulsive force acting between the side of the sheet material facing away from the elongated body of the food product and the region between the stacking area and the slicing tool may be generated, which urges the leading end portion of the sheet material in direction to the leading end face of the elongated body of the food product.

In one aspect, the electrostatic charging system is configured to electrostatically charge the sheet material at a side facing away from the elongated body of the food product, and to electrostatically charge the stacking area with an opposite charge. The oppositely charged faces of the sheet material and the stacking area generate an attractive force between each other.

In one aspect, a side of the sheet material facing to the elongated body of the food product may be electrostatically charged oppositely to the side facing away from the elongated body of the food product. As a result, a repulsive force acting between the side of the sheet material facing the elongated body of the food product and the region between the stacking area and the slicing tool may be generated, which urges the leading end portion of the sheet material in direction to the stacking area.

In one aspect, the electrostatic charging system is configured to provide anions or cations.

In one aspect, the electrostatic charging system comprises at least one, but may also comprise a plurality of, electrostatic charging devices. The sheet material, the food product, and/or the feeding region may be electrically charged by different electrostatic charging devices.

In one aspect, the plurality of electrostatic charging devices comprise a first electrostatic charging device configured to electrostatically charge the sheet material at a side facing the slicing station, and/or a second electrostatic charging device configured to electrostatically charge the sheet material at a side facing away from the slicing station, and/or a third electrostatic charging device configured to electrostatically charge the food product, for example, directly or via the feeding region.

In one aspect, at least one of the first electrostatic charging device, the second electrostatic charging device and/or the third electrostatic charging device may be configured as an ionization rod.

In one aspect, the first electrostatic charging device and/or the second electrostatic charging device may be arranged at or in the feed device.

In one aspect, the sheet material may be fed beneath an elongated body of the food product and sliced into sheets by a slicing tool of the slicing station simultaneously with the elongated body of the food product after coupling to the food product.

In one aspect, a portioning conveyor may be arranged in the stacking area for conveying stacked slices of the food product and sheets of the sheet material.

In one aspect, the feed device may intermittently feed the sheet material into the feeding region.

In one aspect, a method for coupling a sheet material to a food product sliced by a slicing machine is provided. The method comprises feeding a sheet material for positioning between slices of the food product and generating an electrostatic charge to generate a force urging (acting upon) the sheet material to move in a direction to the food product.

In one aspect, the method may provide the same advantages as the sheet interleaver according to any one or more of the above aspects.

In one aspect, the force urges the sheet material to move in a direction toward and/or to a previously cut slice of the food product or a slice to be cut of the food product.

In one aspect, the electrostatic charge generates an attractive force and/or a repulsive force urging the sheet material to move in a direction to the food product.

In one aspect, the force urges the sheet material to couple with the food product.

In one aspect, the step of generating an electrostatic charge comprises electrostatically charging the sheet material, the food product, and/or a feeding region into which the sheet material is fed for positioning between the slices of the food product.

In one aspect, the method may further comprise simultaneously slicing one slice of the food product and one sheet of the sheet material by a slicing tool of the slicing station.

In one aspect, the one slice of the food product may fall onto the sheet of the sheet material already attached to a previous slice of the food product resting on a stacking area. Alternatively, the one slice of the food product may fall together with the coupled one sheet of the sheet material onto a stacking area or onto a previous slice of the food product.

Numerous other advantages and features of the present disclosure will become readily apparent from the following detailed description of the present disclosure and the embodiments thereof, from the claims and from the accompanying drawings.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 is an elevational view of one example of a portion of a sheet interleaver of a slicing machine, the sheet interleaver is shown in a first position and/or first step, according to one aspect of the present disclosure.

FIG. 2 is an elevational view of the sheet interleaver shown in FIG. 1 in a second position and/or second step subsequent to the first position and/or the first step, according to one aspect of the present disclosure.

FIG. 3 is an elevational view of the sheet interleaver shown in FIG. 1 in a third position and/or third step subsequent to the second position and/or the second step, according to one aspect of the present disclosure.

FIG. 4 is an elevational view of the sheet interleaver shown in FIG. 1 in a fourth position and/or fourth step subsequent to the third position and/or the third step, according to one aspect of the present disclosure.

FIG. 5 is an elevational view of the sheet interleaver shown in FIG. 1 in a fifth position and/or fifth step subsequent to the fourth position and/or the fourth step, according to one aspect of the present disclosure.

FIG. 6 is an elevational view of another example of a portion of a sheet interleaver of a slicing machine, according to one aspect of the present disclosure.

FIG. 7 is a schematic diagram of one example of a slicing machine including any of the examples of sheet interleavers disclosed herein and alternatives thereof, according to one aspect of the present disclosure.

### DETAILED DESCRIPTION

While the present disclosure is susceptible of embodiment in many different forms, there are shown in the drawings, and will be described herein in detail, specific embodiments thereof with the understanding that the present disclosure is to be considered as an exemplification of the principles of the present disclosure and is not intended to limit the present disclosure to the specific embodiments illustrated.

The embodiments shown in the figures are at least partially identical. Similar and identical parts are identified with the same reference signs, and for describing those parts it is also referred to the description of the other embodiments and figures, respectively, to avoid repetitions.

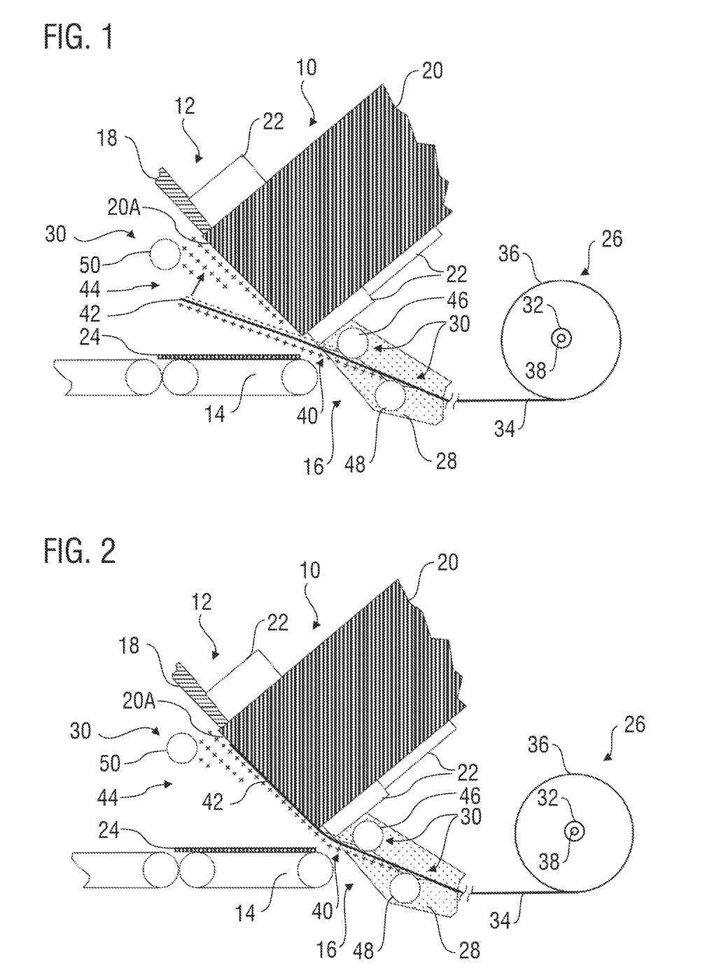

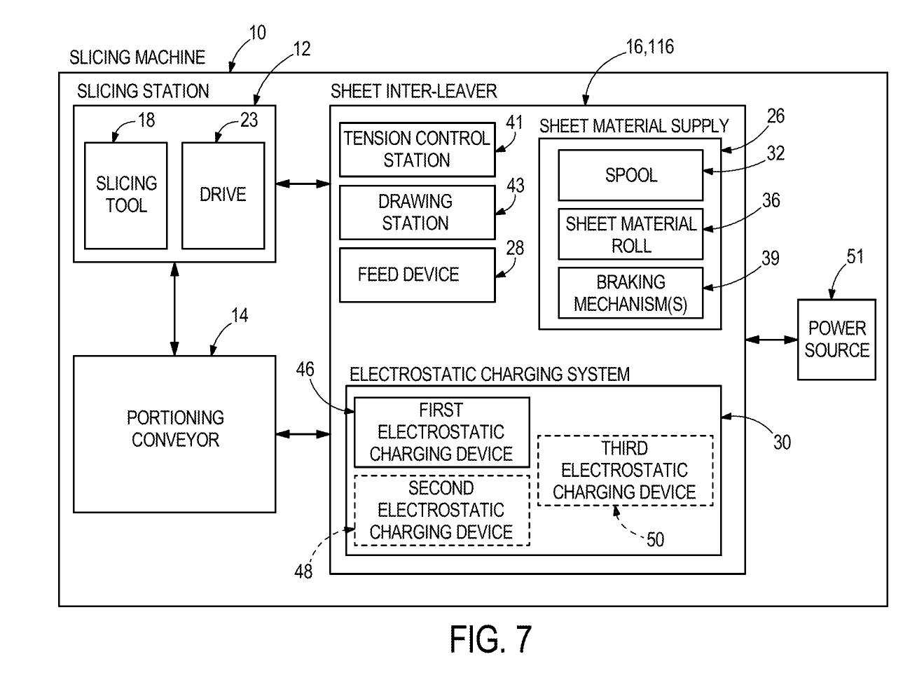

FIG. 1 shows one example of a sheet interleaver 16. The sheet interleaver 16 is coupled to a slicing station 12 of a slicing machine 10. One example of a slicing machine 10 is illustrated in FIG. 7. This example of the slicing machine 10 is provided to demonstrate at least some of the principles of the present disclosure and is not intended to be limiting upon the present disclosure. A portioning conveyor 14 is arranged below the slicing station 12 for receiving slices of food product from the slicing station 12 and sheets of sheet material from the sheet interleaver 16.

The slicing machine 10 may be configured as a high-speed food loaf slicing machine that slices one, two, or more elongated bodies 20 of food product simultaneously. For slicing the elongated bodies 20 of food product, one cyclically driven slicing tool 18, for example a slicing blade, may be used. The slicing machine 10 may include independent loaf feed drives provided so that slices cut from one loaf may vary in thickness from slices cut from another loaf. For the sake of clarity, throughout the drawings of the present disclosure, only one elongated body or loaf 20 of food product is shown and referred to in the following. However, it should be understood that he disclosure herein can apply to any number of rows of elongated bodies or loaves 20 of food product.

The slicing machine 10 includes the slicing station 12. The slicing station 12 is enclosed by a housing 21, except for a limited slicing opening. The elongated body 20 of food product is guided in the slicing station 12 by slicing bars or rails 22. The slicing tool 18 is disposed in the slicing station 12. A drive 23 rotates the slicing tool 18 at a predetermined cyclical rate on a cutting path through a slicing plane. The slicing plane intersects the elongated body 20 of food product as the elongated body 20 is fed into the slicing station 12 to slice the elongated body 20 of food product.

For example, the slicing machine 10 can be a high speed slicing machine such as disclosed in U.S. Pat. Nos. 6,484,615; 5,628,237; 5,649,463; 5,704,265; 5,724,874; and U.S. Published Patent Applications US 2009/0188363 A1; and US 2012/0073249 A1, all herein incorporated by reference, to the extent that the references are not contrary to the present specification, or as commercially available as a FX 180®, FX Plus®, PowerMax3000™, Power Max3500™, PowerMax4000™, and PowerMax4500® slicing machine and/or system available from Formax, Inc. of Mokena, Ill., USA.

Slices 24 of the food product (only one slice 24 is shown in FIG. 1) fall down as they are cut by the slicing tool 18 of the slicing machine 10. The slices 24 are received on the portioning or receiving conveyor 14. The portioning conveyor 14 is disposed adjacent the slicing tool 18 and beneath the slicing station 12. The portioning conveyor 14 serves as a stacking area for stacking the slices 24 and sheets of sheet material. The portioning conveyor 14 transfers the stacks from the slicing machine 10.

The sheet interleaver 16 may comprise a sheet material supply 26, a feed device 28, and an electrostatic charging system 30.

The sheet material supply 26 includes a spool 32 for dispensing sheet material 34 from a sheet material roll 36. For example, the sheet or interlayer material 34 may be foil (for example plastic foil) or paper or any other suitable material for positioning between food product slices. The spool 32 may be rotatably supported on a cylindrical shaft 38 to allow the sheet material roll 36 to revolve about the shaft 38 for dispensing the sheet material 34. Additionally, braking mechanisms 39 may be disposed within the shaft 38 of the sheet material supply 26 for breaking the spool 32 if desired. The sheet material 34 extends from the sheet material roll 36 to the feed device 28. The sheet material 34 may be threaded through a tension control station 41 and guided through a drawing station 43 before reaching the feed device 28.

The feed device 28 receives the sheet material 34 from the sheet material supply 26. The feed device 28 guides the sheet material 34 to a cutting nip 40. Whenever it is desired to slice a sheet of the sheet material 34 for positioning between slices of food product, a leading end portion 42 of the sheet material 34 is fed into a region 44 defined between the slicing tool 18 and the portioning conveyor 14. The leading end portion 42 protrudes over the cutting nip 40.

For example, the sheet material supply 26, the tension control station, the drawing station and the feed device or station 28 may be configured as disclosed by US 2012/0073249 A1.

In the shown examples, the electrostatic charging system 30 includes a first electrostatic charging device 46, a second electrostatic charging device 48 and a third electrostatic charging device 50. The electrostatic charging devices 46, 48, 50 may be connected to a power source 51.

The first electrostatic charging device 46 is disposed in the feed device 28 for electrostatically charging the sheet material 34 on a side facing the elongated body 20 of food product. In one example, the first electrostatic charging device 46 electrostatically charges the sheet material 34 without contacting the sheet material 34 by providing negatively charged ions (anions) in direction to the passing sheet material 34. In one example, as a result of the operation of the first electrostatic charging device 46, the side of the leading end portion 42 facing the slicing station 12 is negatively charged. In another example, the first electrostatic charging device 46 may contact the sheet material 34. In another example, the first electrostatic charging device 46 may provide positively charged ions (cations) in direction to the passing sheet material 34.

The second electrostatic charging device 48 is disposed in the feed device 28 for electrostatically charging the sheet material on the side facing the portioning conveyor 14. In one aspect, similar to the first electrostatic charging device 46, the second electrostatic charging device 48 electrostatically charges the passing leading end portion 42 of the sheet material 34 without contacting the same. In one example, the second electrostatic charging device 48 provides positively charged ions (cations) in direction to the passing sheet material 34. In one example, as a result of the operation of the second electrostatic charging device 48, the side of the leading end portion 42 facing the portioning conveyor 14 is positively charged. In one example, the second electrostatic charging device 48 may contact the sheet material 34. In one example, the second electrostatic charging device 48 may provide negatively charged ions (anions) in direction to the passing sheet material 34.

The third electrostatic charging device 50 is disposed adjacent the slicing station 12 to electrostatically charge the region 44 in a portion above the leading end face 42 of the sheet material 34. Thereby, a leading end face 20A of the elongated body 20 of food product is also electrostatically charged. In one example, the electrostatic charging device 50 provides positively charged ions (cations) to the leading end face 20A of the elongated body 20 of the food product.

In one example, the first, second and third electrostatic charging devices 46, 48 and 50 may be configured as ionization rods.

FIGS. 1-5 show examples of successive positions and/or steps of the sheet interleaver as sheets of material are interleaved under/between slices of food product.

In the position and/or step shown in FIG. 1, one slice 24 of food product has already been sliced and placed on the portioning conveyor 14. The elongated body 20 of product has already been fed in position for slicing by the slicing tool 18 that has not yet engaged the elongated body 20 of food product. The leading end portion 42 of the sheet material 34 has already been fed into the region 44 for slicing by the slicing tool 18 that has also not yet engaged the sheet material 34.

The electrostatically charged leading end portion 42 and the leading end face 20A generate an attractive force (see arrow in FIG. 1) between each other. For example, the attractive force is generated between the negatively charged side of the leading end portion 42 facing the leading end face 20A, and the positively charged leading end face 20A. The attractive force urges the leading end portion 42 in a direction toward and to the leading end face 20A.

In the position and/or step shown in FIG. 2, the leading end portion 42 and the leading end face 20A contact each other. The slicing tool 18 has not yet engaged (started to slice) the elongated body 20 of food product or the leading end portion 42 of the sheet material 34.

The leading end portion 42 is attached or coupled to the leading end face 20A under influence of the attractive force (cf. FIG. 1). Moreover, during pivoting of the leading end portion 42 in a direction toward and to the leading end face 20A, the leading end portion 42 passed the positively charged region in front of the leading end face 20A. When passing through said positively charged region, a repulsive force acting between the positively charged side of the leading end portion 42 and said positively charged region is generated. Said repulsive force further acts to urge the leading end portion 42 in a direction toward and to the leading end face 20A.

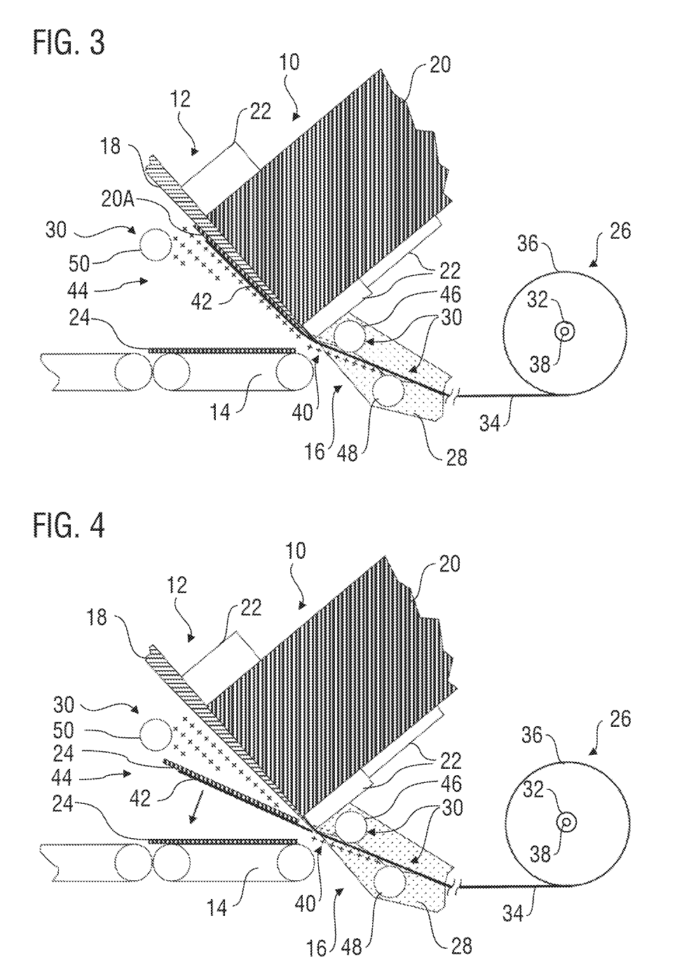

In the position and/or step shown in FIG. 3, the slicing tool 18 simultaneously slices one slice 24 from the elongated body 20 of food product and one sheet of the sheet material 34 corresponding to the leading end portion 42. During slicing, the leading end portion 42 contacts the leading end face 20A of the elongated body 20 of food product.

In the position and/or step shown in FIG. 4, the slice 24 and the sheet (the sliced leading end portion) 42 together fall onto the previous slice 24 already placed on the portioning conveyor 14. During falling, the slice 24 and the sheet 42 maintain a close contact so that a relative displacement between the slice 24 and the sheet 42 is prevented or at least reduced.

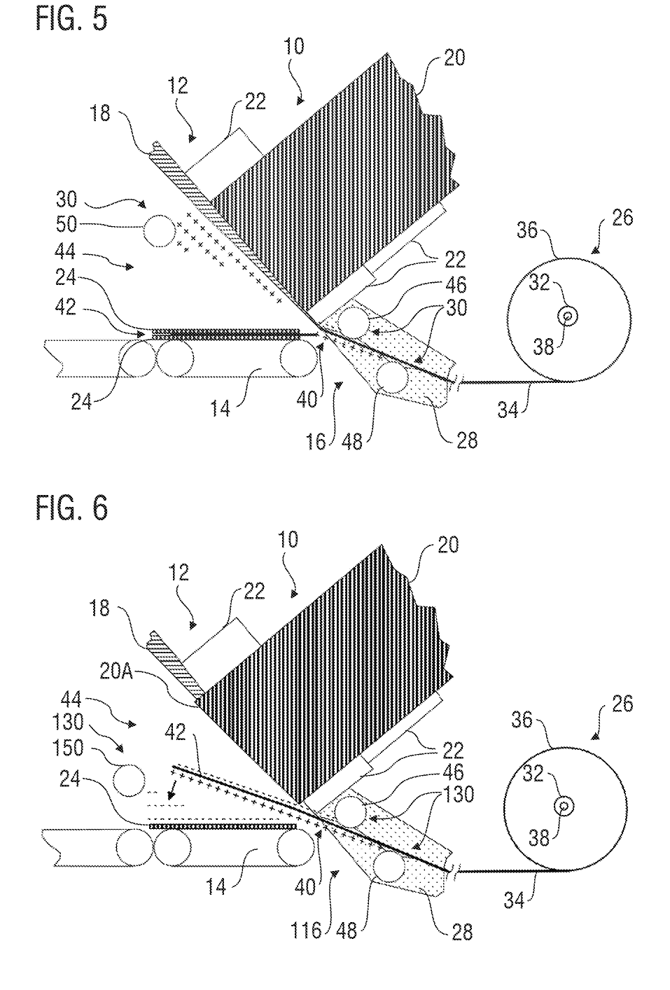

The slice 24 recently cut and the sheet 42 land onto the previous slice 24 of food product as shown in the position and/or step of FIG. 5. The operation cycle may restart again as shown in FIG. 1. Further slices 24 and sheets 42 build up a stack, which is transferred from the slicing machine 10 by the portioning conveyor 14 when reaching a desired height or weight.

Referring to FIG. 6, another example of a sheet interleaver 116 is depicted. In this example, the sheet interleaver 116 includes a third electrostatic charging device 150 arranged to influence a static electricity of the region 44 in a portion below the leading end portion 42 of the sheet material 34. Thereby, the slice 24 of food product and an upper belt face of the portioning conveyor 14 is also electrostatically charged. In one example, the electrostatic charging device 150 provides negatively charged ions (anions). In one example, the third electrostatic charging device 150 may directly contact a belt of the portioning conveyor 14 to electrostatically charge the same.

The electrostatically charged leading end portion 42 and the slice 24 generate an attractive force (see arrow in FIG. 6) between each other. In one example, the attractive force is generated between the positively charged side of the leading end portion 42 facing the portioning conveyor 14, and a negatively charged upper face of the slice 24 of food product. The attractive force urges the leading end portion 42 in direction to the portioning conveyor 14. Moreover, during pivoting of the leading end portion 42 in a direction toward and to the portioning conveyor 14, the leading end portion 42 passes the negatively charged region above the portioning conveyor 14. When passing through said negatively charged region, a repulsive force acting between the negatively charged side of the leading end portion 42 and said negatively charged region is generated. Said repulsive force further acts to urge the leading end portion 42 in a direction toward and to the portioning conveyor 14. In one example, the polarity (positive and negative) of the electrostatic charges to the sheet material 34 and the slices 24 may be reversed.

In one example, only one or two of the first, second and third electrostatic charging devices may be provided. Additionally or alternatively, for example, the first and/or second electrostatic charging devices may be integrated into a drive roller, and/or a dancer roller of the feed device 28, the drawing station and/or the tension control station guiding the sheet material. Furthermore, it should be appreciated that feeding of the sheet material may be controlled such that sheets of sheet material may be provided between every n-th slice of food product, n being a natural number greater than zero, for example 1, 2, 3, etc.

In one example, the third electrostatic charging device and/or an additional electrostatic charging device may be arranged to electrostatically charge a region below the leading end portion of the sheet material to generate a repulsive force urging the leading end portion in direction to the leading end face of the elongated body of food product. Alternatively, the third electrostatic charging device and/or an additional electrostatic charging device may be arranged to electrostatically charge a region above the leading end portion of the sheet material to generate a repulsive force urging the leading end portion in direction to the portioning conveyor.

Further, it is emphasized that generation of a force acting upon the sheet material to move in the direction toward and to the food product is based on the generation of a potential difference resulting from the generation of an electrostatic charge by the electrostatic charging system. Particularly, the potential difference may be generated between positively and negatively charged elements, or between charged elements and grounded elements. As an example, the sheet material may be electrostatically charged, whereas the food material and/or the slicing station may be grounded.

Still further, it will be appreciated that the sheet interleaver as disclosed herein uses an innovative method for attaching the sheet material to the food product. Particularly, the method comprises feeding the sheet material 34 for positioning between slices 24 of the food product and generating an electrostatic charge to generate a force urging the sheet material 34 to move in a direction toward and/or to the food product.

From the foregoing, it will be observed that numerous variations and modifications may be effected without departing from the spirit and scope of the present disclosure. It is to be understood that no limitation with respect to the specific apparatus illustrated herein is intended or should be inferred.

All references, including publications, patent applications, and patents, cited herein are hereby incorporated by reference to the same extent as if each reference were individually and specifically indicated to be incorporated by reference and were set forth in its entirety herein.

It should be understood that the use of any orientation or directional terms herein such as, for example, “top”, “bottom”, “front”, “rear”, “back”, “left”, “right”, “side”, etc., is not intended to imply only a single orientation of the item with which it is associated or to limit the present disclosure in any manner. The use of such orientation or directional terms is intended to assist with the understanding of principles disclosed herein and to correspond to the exemplary orientation illustrated in the drawings. For example, the cooking devices and any component thereof may be utilized in any orientation and use of such terms is intended to correspond to the exemplary orientation of the cooking devices and its components illustrated in the drawings. The use of these terms in association with the cooking devices and their components are not intended to limit the cooking devices or its components to a single orientation or to limit the cooking devices and their components in any manner.

The Abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While various embodiments of the disclosure have been described, it will be apparent to those of ordinary skill in the art that other embodiments and implementations are possible within the scope of the disclosure. Accordingly, the disclosure is not to be restricted except in light of the attached claims and their equivalents.

1. A sheet interleaver for a slicing machine having a slicing station for slicing a food product, the sheet interleaver comprising:
a feed device for providing a sheet material between slices of the food product; and
an electrostatic charging system configured to generate an electrostatic charge, wherein the electrostatic charge generates a force urging the sheet material to move in a direction toward the food product.

2. The sheet interleaver of claim 1, wherein the electrostatic charge generates a force urging the sheet material to move in a direction toward a previously cut slice of the food product or a slice to be cut of the food product.

3. The sheet interleaver of claim 1, wherein the electrostatic charge generates one of an attractive force or a repulsive force urging the sheet material to move in a direction toward the food product.

4. The sheet interleaver of claim 1, wherein the force urges the sheet material to engage the food product.

5. The sheet interleaver of claim 1, wherein the force urges the sheet material to couple with the food product.

6. The sheet interleaver of claim 5, wherein the sheet material is coupled with the food product by the electrostatic charge.

7. The sheet interleaver of claim 1, wherein a leading end portion of the sheet material is urged to move in the direction toward the food product.

8. The sheet interleaver of claim 1, wherein the electrostatic charging system is configured to electrostatically charge the sheet material.

9. The sheet interleaver of claim 8, wherein the electrostatic charging system is configured to electrostatically charge the sheet material at one of a side facing the slicing station or a side facing away from the slicing station.

10. The sheet interleaver of claim 8, wherein the electrostatic charging system is configured to electrostatically charge the sheet material by one of direct contact with the sheet material or by electrostatically charging air or gas contacting the sheet material.

11. The sheet interleaver of claim 1, wherein the electrostatic charging system is configured to electrostatically charge the food product.

12. The sheet interleaver of claim 11, wherein the electrostatic charging system is configured to electrostatically charge at least one of a slice to be cut of the food product and a previously cut slice of the food product.

13. The sheet interleaver of claim 11, wherein the electrostatic charging system is configured to electrostatically charging the food product by direct contact or by electrostatically charging air or gas contacting the food product.

14. The sheet interleaver of claim 1, wherein the electrostatic charging system is configured for electrostatically charge air or gas in a feeding region into which the sheet material is provided by the feed device for positioning between the slices of the food product.

15. The sheet interleaver of claim 1, wherein the electrostatic charging system comprises a plurality of electrostatic charging devices.

16. The sheet interleaver of claim 15, wherein the plurality of electrostatic charging devices includes as least two of:
a first electrostatic charging device configured to electrostatically charge the sheet material at a side facing the slicing station;
a second electrostatic charging device configured to electrostatically charge the sheet material at a side facing away from the slicing station; and
a third electrostatic charging device configured to electrostatically charge the food product.

17. The sheet interleaver of claim 16, wherein at least one of the first electrostatic charging device, the second electrostatic charging device and the third electrostatic charging device is configured as an ionization rod.

18. The sheet interleaver of claim 1, wherein the force urging the sheet material to move in a direction toward the food product further comprises the force urging the sheet material to move in a direction toward a previously cut slice of the food product.

19. The sheet interleaver of claim 1, wherein the food product is an elongated body of food product, and further comprising the urging force urging the sheet material to move in a direction toward the elongated body of the food product.

20. A method for coupling a sheet material to a food product configured to be sliced by a slicing machine, the method comprising:
feeding a sheet material for positioning between slices of the food product; and
generating an electrostatic charge to generate a force urging the sheet material to move in a direction toward the food product.

21. The method of claim 20, wherein the force urges the sheet material to move in a direction toward one of a previously cut slice of the food product or a slice to be cut of the food product.

22. The method of claim 20, wherein the electrostatic charge generates one of an attractive force or a repulsive force urging the sheet material to move in a direction toward the food product.

23. The method of claim 20, wherein the force urges the sheet material to engage the food product.

24. The method of claim 20, wherein the force urges the sheet material to couple with the food product.

25. The method of claim 20, wherein the step of generating an electrostatic charge further comprises electrostatically charging at least one of the sheet material, the food product, and a feeding region into which the sheet material is fed for positioning between the slices of the food product.
